(19) United States
(12) Patent Application Publication
(10) Pub. No.: US 2015/0140249 A1
(43) Pub. Date: May 21, 2015

(54) ADHESIVE COMPOSITION HAVING HIGH FLEXIBILITY

(71) Applicant: LG Hausys, Ltd., Seoul (KR)

(72) Inventors: Chan Oh Yoon, Cheongju-si (KR); Jang Soon Kim, Seongnam-si (KR); Min Seok Song, Anyang-si (KR); Eun Kyung Park, Seoul (KR); Bu Gi Jung, Anyang-si (KR)

(73) Assignee: LG Hausys, Ltd, Seoul (KR)

(21) Appl. No.: 14/402,267

(22) PCT Filed: Dec. 24, 2012
(86) PCT No.: PCT/KR2012/011388

§ 371 Date: Nov. 19, 2014

(30) Foreign Application Priority Data
May 24, 2012 (KR) 10-2012-0055636

(51) Int. Cl. C09J 133/14; C09J 7/02

(52) U.S. Cl. CPC C09J 133/14; C09J 7/02
USPC 428/41.3; 526/282; 525/330.3; 522/108

(57) ABSTRACT

The present invention relates to an adhesive composition comprising: an alkyl acrylic acid ester monomer having an alkyl carbon number of 2 to 14; an acrylic acid ester monomer containing a hydroxyl group; and a copolymer obtained by copolymerizing an acrylic acid ester monomer. The present invention also provides the adhesive composition and an adhesive film using the same, a touch panel, and an electronic device. The adhesive composition of the present invention has characteristics of high flexibility and good cutting properties, durability, transparency, etc.

### TECHNICAL FIELD

The present invention relates to an adhesive composition for touch panels.

The adhesive composition according to the present invention exhibits excellent flexibility and adhesion and thus can eliminate a print step even with a thin thickness.

### BACKGROUND ART

Touchscreens block light by printing a window glass in black or white. Here, black printing requires a high print height from 20 μm to 30 μm, and white printing requires a high print height from 30 μm to 50 μm to realize a color. To eliminate such a print step, an optically clear adhesive (OCA) film having a thickness of about 250 μm is generally used.

Recently, with the trend of producing lighter-weight and thinner smartphones and tablet PCs, an OCA film used in touch panels, that is, an adhesive film, is also required to reduce thickness by increasing flexibility thereof. However, there is a problem in that typical acrylic adhesives suffer from deterioration in cuttability and workability upon cell processing and the like if flexibility of the adhesives is increased.

For example, Japanese Patent Laid-open Publication No. 2010-260880 discloses a double-sided adhesive tape in which a foam substrate has an adhesive layer on both surfaces thereof and the adhesive layer contains a rosin ester adhesion-imparting resin as well as an acrylic copolymer which includes a methacrylate and carboxyl group-containing vinyl monomer as monomer components. However, although the adhesive tape of the publication can exhibit good adhesion, the adhesive tape does not ensure print step elimination capabilities based on excellent flexibility.

To resolve such problems, the inventors of the present invention have tried to develop an adhesive composition exhibiting excellent cuttability, durability and the like while eliminating a print step even with thin thickness based on high flexibility thereof. As a result, the inventors founded that when an adhesive was prepared using a copolymer obtained by copolymerization of specific acrylic monomers, the adhesive could eliminate a print step even with a thickness thereof from 10 μm to 200 μm and exhibit excellent cuttability, durability, transparency and the like, and thus completed the present invention.

### DISCLOSURE

### Technical Problem

It is an aspect of the present invention to provide an adhesive composition which can eliminate a print step with thin thickness due to high flexibility thereof and exhibit excellent cuttability, durability and the like.

### Technical Solution

In accordance with one aspect of the present invention, an adhesive composition includes a copolymer obtained by copolymerization of a C₂ to C₁₄ alkyl acrylic acid ester monomer, a hydroxyl group-containing acrylic acid ester monomer, and an acrylic acid ester monomer, wherein the adhesive composition has a shear modulus from 15,000 Pa to 40,000 Pa, as measured at 60° C. using an ARES instrument.

In accordance with another aspect of the present invention, an adhesive film, a touch panel and an electronic apparatus include the adhesive composition as set forth above.

### Advantageous Effects

According to the present invention, the adhesive composition can eliminate a print step even with thin thickness due to high flexibility thereof and exhibit high cuttability, durability and transparency.

### DESCRIPTION OF DRAWINGS

FIG. 1 shows an adhesive film according to the present invention.

### BEST MODE

One aspect of the present invention relates to an adhesive composition, which includes a copolymer obtained by copolymerization of a C₂ to C₁₄ alkyl acrylic acid ester monomer, a hydroxyl group-containing acrylic acid ester monomer and an acrylic acid ester monomer, wherein the adhesive composition has a shear modulus from 15,000 Pa to 40,000 Pa, as measured at 60° C. using an ARES instrument.

Another aspect of the present invention relates to an adhesive film, which includes: an adhesive layer formed of the adhesive composition according to the present invention; and release liners disposed on both surfaces of the adhesive layer, respectively.

A further aspect of the present invention relates to a touch panel including an adhesive layer formed of the adhesive composition according to the present invention, and to an electronic apparatus including the above touch panel.

The above and other aspects, features, and advantages of the present invention will become apparent from the detailed description of the following embodiments in conjunction with the accompanying drawings. However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof. Like components will be denoted by like reference numerals throughout the specification.

Hereinafter, an adhesive composition exhibiting high flexibility and an adhesive film manufactured from the adhesive composition according to the present invention will be described in detail with reference to the accompanying drawings.

C₂ to C₁₄ Alkyl Acrylic Acid Ester Monomer

According to the present invention, the C₂ to C₁₄ alkyl acrylic acid ester monomer is selected from the group consisting of ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, n-octyl (meth)acrylate, isooctyl (meth)acrylate, isononyl (meth)acrylate, lauryl (meth)acrylate, and tetradecyl (meth)acrylate. Preferably, the alkyl acrylic acid ester monomer is 2-ethylhexyl acrylate.

If the number of carbon atoms of the alkyl group contained in the alkyl acrylic acid ester monomer is greater than 15, the adhesive composition can exhibit an increased glass transition temperature (Tg), or it is difficult to adjust adhesion thereof.

Hydroxyl Group-Containing Acrylic Acid Ester Monomer

According to the present invention, the hydroxyl group-containing acrylic acid ester monomer is selected from the group consisting of 2-hydroxyethyl (meth)acrylate, 2-hydroxypropyl (meth)acrylate, 4-hydroxybutyl (meth)acrylate, 2-hydroxyethyleneglycol (meth)acrylate, and 2-hydroxypropyleneglycol (meth)acrylate. Preferably, the hydroxyl group-containing acrylic acid ester monomer is 2-hydroxyethyl acrylate.

According to the present invention, the hydroxyl group-containing acrylic acid ester monomer is present in an amount of 2 parts by weight to 60 parts by weight based on 100 parts by weight of the alkyl acrylic acid ester monomer. If the hydroxyl group-containing acrylic acid ester monomer is present in an amount of less than 2 parts by weight or not present, the adhesive composition exhibits deterioration in peel strength and cuttability. In addition, if the amount of the hydroxyl group-containing acrylic acid ester monomer is greater than 60 parts by weight, although the adhesive can has improved cuttability, there are problems in that the adhesive becomes hard and thus exhibits deterioration in adhesion with respect to a substrate and deterioration in processability due to increased viscosity thereof.

Acrylic Acid Ester Monomer

According to the present invention, the adhesive composition includes the acrylic acid ester monomer other than C₂ to C₁₄ alkyl acrylic acid ester monomer and the hydroxyl group-containing acrylic acid ester monomer. The acrylic acid ester monomer has a bulky structure. Here, the bulky structure may be a bicyclic structure.

According to the present invention, the bulky acrylic acid ester monomer may be isobornyl acrylate or isoborbyl methacrylate. Preferably, the bulky-structured acrylic acid ester monomer is isobornyl acrylate.

According to the present invention, the bulky-structured acrylic acid ester monomer is present in an amount of 2 parts by weight to 70 parts by weight based on 100 parts by weight of the alkyl acrylic acid ester monomer. If the bulky acrylic acid ester monomer is present in an amount of less than 2 parts by weight or is not present, the adhesive composition can exhibit deterioration in peel strength and cuttability. In addition, if the amount of the bulky-structured acrylic acid ester monomer is greater than 70 parts by weight, the adhesive composition can exhibit improved cuttability. However, in this case, there is a problem in that the adhesive composition becomes hard and thus exhibits deterioration in adhesion with respect to the substrate.

Coupling Agent

According to the present invention, the adhesive composition includes a coupling agent. The coupling agent may be any coupling agent typically used for adhesive compositions using an acrylic resin without limitation. For example, the coupling agent may be a silicone coupling agent, and the like. For example, the coupling agent may include γ-glycidoxypropyltrimethoxysilane, γ-glycidoxypropylmethyldiethoxysilane, γ-glycidoxypropyltriethoxysilane, 3-mercaptopropyltrimethoxysilane, vinyltrimethoxysilane, vinyltriethoxysilane, γ-mathacryloxypropyltrimethoxysilane, γ-methacryloxypropyltriethoxysilane, γ-aminopropyltrimethoxysilane, γ-aminopropyltriethoxysilane, 3-isocyanate propyltriethoxysilane, γ-acetoacetate propyltrimethoxysilane, and the like. These may be used alone or in combination thereof.

According to the present invention, the coupling agent is present in an amount of 0.01 parts by weight to 3.0 parts by weight based on 100 parts by weight of the alkyl acrylic acid ester monomer. If the amount of the coupling agent is less than 0.01 parts by weight, coupling cannot sufficiently occur, and if the amount of the coupling agent is greater than 3.0 parts by weight, an unreacted coupling agent can remain as an impurity.

Photoinitiator

According to the present invention, the adhesive composition includes a photoinitiator. The photoinitiator may be any initiator without limitation so long as the initiator can generate radicals by light irradiation and thus initiate polymerization. Specifically, the photoinitiator may include benzoin initiators, hydroxyketone initiators, aminoketone initiators, and the like. More specifically, the photoinitiator may include benzoin, benzoin methyl ether, benzoin benzoin ethyl ether, benzoin isopropyl ether, benzoin n-butyl ether, benzoin isobutyl ether, acetophenone, dimethylamino acetophenone, α,α-methoxy-α-hydroxyacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxyl)phenyl-2-(hydroxy-2-propyl)ketone, benzophenone, 4,4′-diethylaminobenzophenone, dichlorobenzophenone, 2-methylanthraquinone, 2-ethylanthraquinone, 2-t-butyl anthraquinone, 2-amino anthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, oligo[2-hydroxy-2-methyl-1-[4-(1-methylvinyl)phenyl]propanone], and the like, without being limited thereto. These photoinitiators may be used alone or in combination thereof.

As used herein, the term “light irradiation” refers to electromagnetic wave irradiation which can influence photoinitiators or polymerizable compounds to cause polymerization, and the electromagnetic wave is used as a generic term for particle beams, such as α-particle beams, proton beams, neutron beams, and electron beams, as well as microwaves, infrared rays, ultraviolet rays, X-rays and γ-rays.

The photoinitiator may be present in an amount of 0.01 parts by weight to 3.0 parts by weight based on 100 parts by weight of the alkyl acrylic acid ester monomer. If the amount of the photoinitiator is less than 0.01 parts by weight, reaction time can be increased. On the contrary, if the amount of the photoinitiator is greater than 3.0 parts by weight, the unreacted photoinitiator can remain as an impurity.

Curing Agent

According to the present invention, the adhesive composition includes a curing agent. The curing agent may include curing agents known in the art, such as polyfunctional phenols, amines, imidazole compounds, acid anhydrides, organophosphorus compounds and halides thereof, polyfunctional acrylics, urethanes, isocyanates, alcohols, polyamides, polysulfides, and boron trifluoride, without being limited thereto.

According to the present invention, the curing agent may be present in an amount of 0.01 parts by weight to 7.0 parts by weight based on 100 parts by weight of the alkyl acrylic acid ester monomer. If the amount of the curing agent is less than 0.01 parts by weight, curing time can be increased or it can be difficult to perform film formation of the adhesive composition due to insufficient curing. On the contrary, if the amount of the curing agent is greater than 7.0 parts by weight, an unreacted curing agent can remain as an impurity, or the adhesive composition can become too rigid due to over-curing and thus exhibit deterioration in usability.

Molecular Weight Regulator

According to the present invention, the adhesive composition includes a molecular weight regulator. The molecular weight regulator may include molecular weight regulators known in the art, such as thiols, halocarbons, carbon tetrachloride, 2-mercaptoethanol, and 3-mercaptopropionic acid, without being limited thereto. The molecular weight regulator may be present in an amount of 0.005 parts by weight to 5.0 parts by weight based on 100 parts by weight of the alkyl acrylic acid ester monomer. If the amount of the molecular weight regulator is less than 0.005 parts by weight, the molecular weight regulator can provide insufficient molecular weight adjustment. In addition, if the amount of the molecular weight regulator is greater than 5.0 parts by weight, the adhesive composition can suffer from deterioration in film molding due to suppression of curing and suffer from bleeding due to remaining unreacted materials.

Adhesive Film

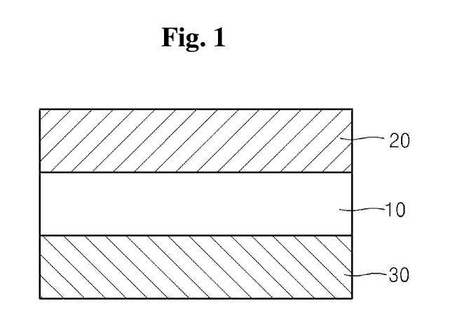

According to the present invention, an adhesive film includes: an adhesive layer 10 formed of the adhesive composition according to the present invention; and release liners 20, 30 on both surfaces of the adhesive layer, respectively (FIG. 1). The adhesive composition according to the present invention is coated onto a first release liner, followed by curing, and then stacked on a second release liner, thereby manufacturing the adhesive film.

Here, the release liners 20, 30 may have different release forces. That is, the first release liner 20 may have a release force from 40 g/2 in to 120 g/2 in, and the second release liner 30 may have a release force from 5 g/2 in to 40 g/2 in. If the release force of the first release liner 20 is less than 40 g/2 in, there is a problem of difficult release of the second release liner, and if the release force of the first release liner 20 is greater than 120 g/2 in, the adhesive film can suffer from deterioration in processability due to difficult release. In addition, if the release force of the second release liner 30 is less than 5 g/2 in, the adhesive film can suffer from tunneling upon processing, and if the release force of the second release liner 30 is greater than 40 g/2 in, the adhesive film can suffer from deterioration in processability due to difficult release.

According to the present invention, the adhesive layer 10 has a thickness from 20 μm to 350 μm, preferably from 50 μm to 250 μm, more preferably from 100 μm to 200 μm. If the thickness of the adhesive layer is less than 20 μm, the adhesive layer becomes thinner than typical light blocking print layers of touchscreens. In addition, if the thickness of the adhesive layer is greater than 350 μm, a touch panel can have a thick thickness, as opposed to the trend of producing thinner touch panels, although the adhesive film has no problem in properties for acting as an adhesive film.

According to the present invention, the adhesive film has a viscosity from 1,000 cPs to 2,000 cPs. Within this range, the adhesive film can exhibits good coatability and stably maintain appearance and properties thereof. If the viscosity of the adhesive film is greater than 2,000 cPs, the adhesive film can suffer from agglomeration upon coating of the adhesive layer, and if the viscosity of the adhesive film is less than 1,000 cPs, the adhesive film can suffer from flow-down upon coating of the adhesive layer, thereby causing thickness deviation.

According to the present invention, the adhesive film has a haze of 0.5% or less. If the haze of the adhesive film is greater than 0.5%, the adhesive film can exhibit deteriorated optical properties. In particular, if the haze of the adhesive film is greater than 1.0%, the adhesive film can become unsuitable for optical purposes due to excessively low transparency.

### MODE FOR INVENTION

### 1. Preparation of Adhesive Film

Components were mixed in amounts as listed in Table 1, respectively, followed by copolymerization at room temperature for 5 minutes, thereby preparing an adhesive composition. The adhesive composition was coated onto a polyethylene terephthalate (PET) liner having a release force of 75 g/2 in, followed by curing, and then stacked on a PET liner having a release force of 30 g/2 in, thereby manufacturing a 175 μm thick adhesive film (Examples 1 to 8, Comparative Examples 1 to 10). Here, Irgacure 651 (Ciba Specialty Chemicals Co., Ltd.) was used as a photoinitiator; toluene diisocyanate was used as a curing agent; and 2-mercaptoethanol was used as a molecular weight regulator.

TABLE 1

| | Example 1 | Example 2 | Example 3 | Example 4 | Example 5 | Example 6 | Example 7 | Example 8 |
|---|---|---|---|---|---|---|---|---|
| 2-ethylhexyl | 100 | 100 | 100 | 100 | 100 | 100 | 100 | 100 |
| acrylate | | | | | | | | |
| 2-hydroxyethyl | 40 | 20 | 60 | 40 | 40 | 40 | 40 | 40 |
| acrylate | | | | | | | | |
| Isobornyl | 70 | 70 | 70 | 40 | 70 | 70 | 70 | 70 |
| acrylate | | | | | | | | |
| Coupling agent | 0.5 | 0.5 | 0.5 | 0.5 | 0.5 | 0.5 | 0.5 | 0.5 |
| Photoinitiator | 0.5 | 0.5 | 0.5 | 0.5 | 0.5 | 0.5 | 0.5 | 0.5 |
| Curing agent | 1 | 1 | 1 | 1 | 7 | 3 | 1 | 1 |
| Molecular | 0.5 | 0.5 | 0.5 | 0.5 | 0.5 | 0.5 | 5 | 0.05 |
| weight regulator | | | | | | | | |

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| 2-ethylhexyl | 100 | 100 | 100 | 100 | 100 | 100 | 100 |
| acrylate | | | | | | | |
| 2-hydroxyethyl | 90 | 40 | 120 | 40 | 40 | 40 | 40 |
| acrylate | | | | | | | |
| Isobornyl | 70 | 90 | 0 | 70 | 70 | 70 | 70 |
| acrylate | | | | | | | |
| Coupling agent | 0.5 | 0.5 | 0.5 | 0.5 | 0.5 | 0.5 | 0.5 |
| Photoinitiator | 0.5 | 0.5 | 0.5 | 0.5 | 0.5 | 0.5 | 0.5 |
| Curing agent | 1 | 1 | 1 | 0 | 1 | 10 | 1 |
| Molecular | 0.5 | 0.5 | 0.5 | 0.5 | 0 | 0.5 | 7 |
| weight regulator | | | | | | | |

| | Comparative Example 8 | Comparative Example 9 | Comparative Example 10 |
|---|---|---|---|
| 2-ethylhexyl acrylate | 100 | 100 | 100 |
| 2-hydroxyethyl acrylate | 40 | — | — |
| 2-hydroxyethyl amide | — | 40 | 40 |
| Isobornyl acrylate | — | 70 | — |
| Hydroxyethyl methyl amide | 70 | — | 70 |
| Coupling agent | 0.5 | 0.5 | 0.5 |
| Photoinitiator | 0.5 | 0.5 | 0.5 |
| Curing agent | 1 | 1 | 1 |
| Molecular weight regulator | 0.5 | 0.5 | 0.5 |

### 2. Property Evaluation of adhesive film

### Experimental Example 1

### Evaluation of Adhesion

Adhesion of each of the adhesive films of Examples 1 to 8 and Comparative Examples 1 to 10 was evaluated in accordance with ASTM D3330 modified. As a result, it was confirmed that all of the adhesive films had good adhesion (Table 2). In particular, it was confirmed that all of the adhesive compositions of Examples 1 to 8 had an adhesive strength from 3000 Win to 4000 Win, as measured in accordance with ASTM D3330 modified.

TABLE 2

| Property | Example 1 | Example 2 | Example 3 | Example 4 | Example 5 | Example 6 | Example 7 | Example 8 |
|---|---|---|---|---|---|---|---|---|
| Adhesive | 3000 | 3500 | 3200 | 4000 | 3800 | 3100 | 3600 | 3000 |
| strength | | | | | | | | |
| (g/in) | | | | | | | | |

| | Comparative | Comparative | Comparative | Comparative | Comparative | Comparative | Comparative |
|---|---|---|---|---|---|---|---|
| Property | Example 1 | Example 2 | Example 3 | Example 4 | Example 5 | Example 6 | Example 7 |
| Adhesive | 3200 | 4000 | 3800 | 3500 | 3100 | 3400 | 4000 |
| strength | | | | | | | |
| (g/in) | | | | | | | |

| | Comparative | Comparative | Comparative |
|---|---|---|---|
| Property | Example 8 | Example 9 | Example 10 |
| Adhesive | 3500 | 3000 | 2800 |
| strength | | | |
| (g/in) | | | |

### Experimental Example 2

### Evaluation of Durability

Each of the adhesive films of Examples 1 to 8 and Comparative Examples 1 to 10 was attached to an ITO film, followed by attachment of a glass substrate. The specimen was stored in an oven at 60° C. and 90% relative humidity for 120 hours, followed by observation of an appearance thereof, thereby checking whether the specimen suffered from bubbling.

As a result, it was confirmed that the adhesive tapes of Examples 1 to 8 did not suffer from bubbling under high temperature and high humidity and thus exhibited outstanding durability. However, the adhesive tapes of Comparative Examples suffered from bubbling. In particular, a large amount of bubbles was observed in the adhesive tapes of Comparative Examples 4 and 7 (Table 3).

TABLE 3

| | Example | Example | Example | Example | Example | Example | Example | Example |
|---|---|---|---|---|---|---|---|---|
| Property | 1 | 2 | 3 | 4 | 5 | 6 | 7 | 8 |
| Durability | ◯ | ◯ | ◯ | ◯ | ◯ | ◯ | ◯ | ◯ |
| (Determination | | | | | | | | |
| as to bubbling | | | | | | | | |
| by naked eye) | | | | | | | | |

| | Comparative | Comparative | Comparative | Comparative | Comparative | Comparative | Comparative |
|---|---|---|---|---|---|---|---|
| Property | Example 1 | Example 2 | Example 3 | Example 4 | Example 5 | Example 6 | Example 7 |
| Durability | Δ | Δ | Δ | X | Δ | Δ | X |
| (Determination | | | | | | | |
| as to bubbling | | | | | | | |
| by naked eye) | | | | | | | |

| | Comparative | Comparative | Comparative |
|---|---|---|---|
| Property | Example 8 | Example 9 | Example 10 |
| Durability | Δ | Δ | Δ |
| (Determination | | | |
| as to bubbling | | | |
| by naked eye) | | | |

◯: No bubbling
Δ: Slight bubbling
X: Severe bubbling

### Experimental Example 3

### Evaluation of Flexibility

Flexibility of the adhesive films of Examples 1 to 8 and Comparative Examples 1 to 10 was evaluated and compared by measuring shear modulus over time using an ARES instrument. Here, an ARES G2 (TA Instruments Co., Ltd.) was used as a measurement instrument.

As a result, the adhesive films of Examples 1 to 8 had a shear modulus from 70000 Pa to 95000 Pa as measured at 20° C., and had a shear modulus from 15000 Pa to 40000 Pa as measured at 60° C. using an ARES instrument. In addition, a difference in shear modulus due to temperature was from 45000 Pa to 65000 Pa. However, most of the adhesive films of Comparative Examples had a higher shear modulus than those of Examples, or some of the adhesive films of Comparative Examples could not be measured due to difficult film formation (Table 4).

TABLE 4

| | | Example | Example | Example | Example | Example | Example | Example | Example |
|---|---|---|---|---|---|---|---|---|---|
| Property | | 1 | 2 | 3 | 4 | 5 | 6 | 7 | 8 |
| Modulus | 20° C. | 72,000 | 75,000 | 85,000 | 73,000 | 95,000 | 70,000 | 80,000 | 78,000 |
| (Pa) | 60° C. | 26,000 | 25,000 | 35,000 | 25,000 | 40,000 | 25,000 | 15,000 | 30,000 |

| | | Comparative | Comparative | Comparative | Comparative | Comparative | Comparative | Comparative |
|---|---|---|---|---|---|---|---|---|
| Property | | Example 1 | Example 2 | Example 3 | Example 4 | Example 5 | Example 6 | Example 7 |
| Modulus | 20° C. | 110,000 | 90,000 | 100,000 | Not | 110,000 | 140,000 | Not |
| (Pa) | | | | | measurable | | | measurable |
| | 60° C. | 75,000 | 70,000 | 80,000 | Not | 90,000 | 125,000 | Not |
| | | | | | measurable | | | measurable |

| | | | |
|---|---|---|---|
| | Comparative | Comparative | Comparative |
| Property | Example 8 | Example 9 | Example 10 |

| | | | | |
|---|---|---|---|---|
| Modulus | 20° C. | 95,000 | 100,000 | 110,000 |
| (Pa) | 60° C. | 50,000 | 55,000 | 60,000 |

### Experimental Example 4

### Evaluation of Print Step Elimination Capabilities

A glass substrate was printed in white so as to have a print step of 40 μm, followed by attaching each of the adhesive tapes of Examples 1 to 8 and Comparative Examples 1 to 10 to the printed surface of the glass substrate. Next, an optical glass was stacked on the adhesive tape, followed by observing whether bubbles were generated near the printed portion, thereby evaluating print step elimination capabilities of the adhesive tape.

As a result, it could be seen that the adhesive tapes having a shear modulus of 40,000 Pa or less at a high temperature, that is, 60° C., exhibited good print step elimination capabilities (Table 5).

TABLE 5

| | Example | Example | Example | Example | Example | Example | Example | Example |
|---|---|---|---|---|---|---|---|---|
| Property | 1 | 2 | 3 | 4 | 5 | 6 | 7 | 8 |
| Print step | ◯ | ◯ | ◯ | ◯ | ◯ | ◯ | ◯ | ◯ |
| elimination | | | | | | | | |
| capabilities (40 μm) | | | | | | | | |

| | Comparative | Comparative | Comparative | Comparative | Comparative | Comparative | Comparative |
|---|---|---|---|---|---|---|---|
| Property | Example 1 | Example 2 | Example 3 | Example 4 | Example 5 | Example 6 | Example 7 |
| Print step | Δ | Δ | X | ◯ | X | X | ◯ |
| elimination | | | | | | | |
| capabilities (40 μm) | | | | | | | |

| | Comparative | Comparative | Comparative |
|---|---|---|---|
| Property | Example 8 | Example 9 | Example 10 |
| Print step | X | ◯ | Δ |
| elimination | | | |
| capabilities (40 μm) | | | |

◯: No bubbling and good print step elimination capabilities
Δ: Slight bubbling
X: Severe bubbling

### Experimental Example 5

### Evaluation of Cuttability

Each of the adhesive films of Examples 1 to 8 and Comparative Examples 1 to 10 was cut with a knife at room temperature, thereby evaluating cuttability (knife cut) based on the degree of sticky residues generation. As a result, although it was confirmed that most of the adhesive films of Examples scarcely suffered from sticky residues and thus exhibited good cuttability, it was confirmed that the adhesive films of Comparative Examples 4 and 7 suffered from severe sticky residues upon cutting thereof (table 6).

TABLE 6

| Property | Example 1 | Example 2 | Example 3 | Example 4 | Example 5 | Example 6 | Example 7 | Example 8 |
|---|---|---|---|---|---|---|---|---|
| Cuttability | ◯ | ◯ | ◯ | ◯ | ◯ | ◯ | ◯ | ◯ |

| | Comparative | Comparative | Comparative | Comparative | Comparative | Comparative | Comparative |
|---|---|---|---|---|---|---|---|
| Property | Example 1 | Example 2 | Example 3 | Example 4 | Example 5 | Example 6 | Example 7 |
| Cuttability | ◯ | ◯ | ◯ | X | ◯ | ◯ | X |

| | Comparative | Comparative | Comparative |
|---|---|---|---|
| Property | Example 8 | Example 9 | Example 10 |
| Cuttability | X | Δ | ◯ |

◯: Almost no sticky residues generation upon cutting
Δ: Slight sticky residues generation upon cutting
X: Severe sticky residues generation upon cutting

### Experimental Example 6

### Evaluation of Viscosity

For each of the adhesive films of Examples 1 to 8 and Comparative Examples 1 to 10, viscosity was measured using a viscometer (Brookfield Co., Ltd.).

As a result, it was confirmed that the adhesive films of Examples 1 to 8 had a viscosity from 1,000 cPs to 2,000 cPs (Table 7). Therefore, it was evaluated that the adhesive films of Examples 1 to 8 would exhibit good coatability and stable appearance and properties.

TABLE 7

| Property | Example 1 | Example 2 | Example 3 | Example 4 | Example 5 | Example 6 | Example 7 | Example 8 |
|---|---|---|---|---|---|---|---|---|
| Viscosity (cPs) | 1,500 | 1,700 | 1,300 | 1,100 | 1,500 | 1,480 | 1,450 | 1,500 |

| | Comparative | Comparative | Comparative | Comparative | Comparative | Comparative | Comparative |
|---|---|---|---|---|---|---|---|
| Property | Example 1 | Example 2 | Example 3 | Example 4 | Example 5 | Example 6 | Example 7 |
| Viscosity (cPs) | 750 | 950 | 1,300 | 1,500 | 1,600 | 1,100 | 950 |

| | Comparative | Comparative | Comparative |
|---|---|---|---|
| Property | Example 8 | Example 9 | Example 10 |
| Viscosity (cPs) | 1,550 | 1,540 | 1,550 |

### Experimental Example 7

### Transparency

Each of the adhesive films of Examples 1 to 8 and Comparative Examples 1 to 10 was cut to a size of 50 mm×50 mm, followed by measuring haze using a haze meter (Gard plus, BYK Co., Ltd.). As a result, it was confirmed that all of the adhesive films of Examples 1 to 8 had a haze from 0.2% to 0.3% (Table 8).

TABLE 8

| Property | Example 1 | Example 2 | Example 3 | Example 4 | Example 5 | Example 6 | Example 7 | Example 8 |
|---|---|---|---|---|---|---|---|---|
| Haze (%) | 0.3 | 0.2 | 0.3 | 0.2 | 0.3 | 0.3 | 0.3 | 0.3 |

| | Comparative | Comparative | Comparative | Comparative | Comparative | Comparative | Comparative |
|---|---|---|---|---|---|---|---|
| Property | Example 1 | Example 2 | Example 3 | Example 4 | Example 5 | Example 6 | Example 7 |
| Haze (%) | 0.8 | 0.8 | 0.8 | 1.2 | 0.5 | 1.0 | 1.2 |

| | Comparative | Comparative | Comparative |
|---|---|---|---|
| Property | Example 8 | Example 9 | Example 10 |
| Haze (%) | 0.8 | 0.8 | 0.8 |

### LIST OF REFERENCE NUMERALS

10: Adhesive layer according to the present invention
20: First release liner
30: Second release liner

### INDUSTRIAL APPLICABILITY

The present invention relates to an adhesive composition including a copolymer obtained by copolymerization of a C₂ to C₁₄ alkyl acrylic acid ester monomer, a hydroxyl group-containing acrylic acid ester monomer and an acrylic acid ester monomer. In addition, the present invention also provides an adhesive film, a touch panel and an electronic apparatus using the adhesive composition.

1. An adhesive composition comprising:
a copolymer obtained by copolymerization of a C₂ to C₁₄ alkyl acrylic acid ester monomer, a hydroxyl group-containing acrylic acid ester monomer, and an acrylic acid ester monomer,
wherein the adhesive composition has a shear modulus from 15,000 Pa to 40,000 Pa, as measured at 60° C. using an ARES instrument.

2. The adhesive composition according to claim 1, wherein the hydroxyl group-containing acrylic acid ester monomer is present in an amount of 2 parts by weight to 60 parts by weight based on 100 parts by weight of the alkyl acrylic acid ester monomer.

3. The adhesive composition according to claim 1, wherein the acrylic acid ester monomer is present in an amount of 2 parts by weight to 70 parts by weight based on 100 parts by weight of the alkyl acrylic acid ester monomer.

4. The adhesive composition according to claim 1, wherein the alkyl acrylic acid ester monomer is selected from the group consisting of ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, n-octyl (meth)acrylate, isooctyl (meth)acrylate, isononyl (meth)acrylate, lauryl (meth)acrylate, and tetradecyl (meth)acrylate.

5. The adhesive composition according to claim 1, wherein the hydroxyl group-containing acrylic acid ester monomer is selected from the group consisting of 2-hydroxyethyl (meth)acrylate, 2-hydroxypropyl (meth)acrylate, 4-hydroxybutyl (meth)acrylate, 2-hydroxyethyleneglycol (meth)acrylate, and 2-hydroxypropyleneglycol (meth)acrylate.

6. The adhesive composition according to claim 1, wherein the acrylic acid ester monomer is isobornyl acrylate or isobornyl methacrylate.

7. The adhesive composition according to claim 1, further comprising:
0.01 parts by weight to 7.0 parts by weight of a curing agent based on 100 parts by weight of the alkyl acrylic acid ester monomer.

8. The adhesive composition according to claim 1, wherein the adhesive composition has an adhesive strength from 3000 On to 4000 On, as measured in accordance with ASTM D3330 modified.

9. The adhesive composition according to claim 1, wherein the adhesive composition has a shear modulus from 70000 Pa to 95000 Pa, as measured at 20° C. using an ARES instrument.

10. The adhesive composition according to claim 1, wherein the adhesive composition has a difference from 45000 Pa to 65000 Pa between a shear modulus measured at 20° C. and a shear modulus measured at 60° C., using an ARES instrument.

11. The adhesive composition according to claim 1, further comprising:
a coupling agent, a photoinitiator, a curing agent, and a molecular weight regulator.

12. An adhesive film comprising:
an adhesive layer formed of the adhesive composition according to claim 1; and
release liners disposed on both surfaces of the adhesive layer, respectively.

13. The adhesive film according to claim 12, wherein the release liners have different release forces.

14. The adhesive film according to claim 12, wherein the adhesive layer has a thickness from 20 μm to 350 μm.

15. A touch panel comprising an adhesive layer formed of the adhesive composition according to claim 1.

16. An electronic apparatus comprising the touch panel according to claim 15.

17. An adhesive film comprising:
an adhesive layer formed of the adhesive composition according to claim 7; and release liners disposed on both surfaces of the adhesive layer, respectively.

18. An adhesive film comprising:
an adhesive layer formed of the adhesive composition according to claim 8; and release liners disposed on both surfaces of the adhesive layer, respectively.

19. An adhesive film comprising:
an adhesive layer formed of the adhesive composition according to claim 9; and release liners disposed on both surfaces of the adhesive layer, respectively.

20. An adhesive film comprising:
an adhesive layer formed of the adhesive composition according to claim 10; and release liners disposed on both surfaces of the adhesive layer, respectively.
